(19) United States
(12) Patent Application Publication
(10) Pub. No.: US 2016/0243763 A1
(43) Pub. Date: Aug. 25, 2016

(54) AN OPTIMIZED METHOD OF THREE-DIMENSIONAL PRINTING

(71) Applicant: BEIJING TIERTIME TECHNOLOGY CO., LTD., Beijing (CN)

(72) Inventor: Ge GUO, Beijing (CN)

(73) Assignee: BEIJING TIERTIME TECHNOLOGY CO., LTD, Beijing (CN)

(21) Appl. No.: 14/786,286

(22) PCT Filed: Nov. 19, 2014
(86) PCT No.: PCT/CN2014/001035

§ 371 Date: Oct. 22, 2015

(30) Foreign Application Priority Data
Sep. 24, 2014 (CN) 201410495935.1

(51) Int. Cl. B29C 67/00

(52) U.S. Cl. CPC B29C 67/0074; B29C 67/0088; B33Y 10/00

(57) ABSTRACT

An optimized three-dimensional printing method, includes: A) generate three-dimensional CAD model; B) separate the three-dimensional CAD model into a series of layers; C) print the separate layers by the method that spray the given composite material through a nozzle; D) the bottom layer is printed through the nozzle on the work platform; E) the layers except the bottom layer are printed after finish printing the bottom layer to form the three-dimensional composite model; the method generate the data of printing bottom layer depend on the concave-convex points on the work platform in procedure B). Compare to existing three-dimensional technology, the analysis of the degree of concave-convex of the work platform generates the corresponding data of printing. The path of printing bottom layer can be confirmed, thereby lowering the requirements of the work platform, reducing the damage to the nozzle and eliminating the phenomenon of warping at the bottom.

### FIELD OF THE INVENTION

The present invention relates to a three-dimensional printing method, which pertains to the optimized method of three-dimensional printing.

### BACKGROUND

Three-dimensional printing, a kind of rapid prototyping, is the technology that prints object layer by layer through using adhesive materials of powdered metal or plastic base on the file of digital model. In the working procedures, the three-dimensional printer prints the model by spraying melt material through a nozzle to carry out the layered accumulation on the work platform. The material accumulates and adheres on the surface of the work platform. And the weak adhesion leads to the warping phenomenon which makes the model apart from the upper surface of the work platform in subsequent printing.

Currently, in order to ensure that the bottom of the model can be well adhered with the upper surface of the work platform, a extremely flat upper surface of the work platform is usually needed in the existing print mode. Otherwise, the concaves or convexes on the surface not only become the nodes of warping of the model but also damage the nozzle due to the pressing. In order to meet this point, the design of the work platform is very limited. However, as shown in FIG. 1, due to the demand of the printer, many intelligent control structure must be set on the work platform. After the setting of the intelligent control structure, the shape of the surface of the work platform will be different. The surface of the work platform will be left with the installation location hole to correct the reference points and concave-convex points. As shown in FIG. 2, the friction and collision between the nozzle and the concave-convex points in the existing print mode can easy lead to warp that the circle place is not bonded firmly.

Therefore, how to lower the requirements of the work platform, reduce the damage to the nozzle and eliminate the phenomenon of warping at the bottom become the targets to those skilled in the art.

### SUMMARY OF THE INVENTION

To achieve that lowering the requirements of the work platform, reducing the damage to the nozzle and eliminating the phenomenon of warping at the bottom in the process of three-dimensional printing, the invention novelly raises an optimized method of three-dimensional printing.

To achieve the above objectives, the technical scheme which is adopted by the invention is an optimized method of three-dimensional printing, the method comprising:

A) generate three-dimensional CAD model;

B) separate the three-dimensional CAD model into a series of layers;

C) print the separate layers by the method that spray the given composite material through a nozzle;

D) the bottom layer (3) is printed through the nozzle on the work platform;

E) the layers except the bottom layer are printed after finish the printing of the bottom layer (3) to form the three-dimensional composite model;

characterized that the method generate the data of the printing of bottom layer (3) depend on the concave-convex points (2) on the work platform (1) in procedure B).

Existing three-dimensional printing technology requires the pre-designed model to determine the print path in the software model analysis and hierarchical processing such that a high quality work platform is needed to print the bottom layer. Compare to the existing technology, the invention innovate the analysis of the degree of concave-convex of the work platform to generate the corresponding data of printing before the bottom layer is printed. The path of printing bottom layer can be changed, thereby lowering the requirements of the work platform, reducing the damage to the nozzle and eliminating the phenomenon of warping at the bottom.

In addition, the path of printing bottom layer will detour concave-convex points on the work platform by the data of printing bottom layer such that the shape of the printing path varies according to the different work platform.

The nozzle will detour the concave-convex points on the work platform when the nozzle is close to the concave-convex points in printing to avoid touching between the nozzle and concave-convex points according to the data of printing bottom layer. Thus not only the nozzle will not be damaged by concave-convex points but also the extremely flat surface of the work platform is not necessary such that the phenomenon of warping at the bottom part cannot be occurred.

Furthermore, the nozzle moves to left or right and deviate the concave-convex points when the nozzle near to the concave-convex points on the work platform, and then continue to print.

Moreover, the nozzle moves up and over the concave-convex points when the nozzle near to the concave-convex points on the work platform, and then continue to print.

Besides, the nozzle prints around the concave-convex points as a center when the nozzle near to the concave-convex points on the work platform.

What's more, printing the second print layer to cover the concave-convex points which were detoured in the printing of the bottom layer to form a complete plane after finish the printing of the bottom layer, and then complete the printing of the subsequent print layer on that plane.

Due to the specific path of printing bottom layer which is designed base on the surface of the work platform, the printing of bottom layer detours the concave-convex points on the work platform. After the finish of printing bottom layer, the second print layer covers the concave-convex points such that makes the bottom layer be printed densely. Then use the conventional printing method to print the second print layer and the subsequent print layer.

The beneficial effect of the invention is that compare to the existing three-dimensional technology, the invention innovate the analysis of the degree of concave-convex of the work platform to generate the corresponding data of printing, thereby lowering the requirements of the work platform, reducing the damage to the nozzle and eliminating the phenomenon of warping at the bottom.

### BRIEF DESCRIPTION OF THE DRAWINGS

FIG. 1 shows the main view of the work platform with concave-convex points;

FIG. 2 shows the main view of the existing print method that printing bottom layer on the work platform;

FIG. 3 shows the main view that the bottom layer is printed on the work platform by detouring the concave-convex points;

FIG. 4 shows the main view that the bottom layer is printed on the work platform by skipping the concave-convex points;

FIG. 5 shows the main view that the bottom layer is printed on the work platform by circling around the concave-convex points;

FIG. 6 shows that the stereoscopic model is printed layer by layer on the work platform by moving around the concave-convex points;

In the figures,

1. Work platform; 2. Concave-convex points; 3. Bottom layer; 4. The second print layer; 5. The subsequent print layer.

### DETAILED DESCRIPTION

Following is the detailed description of the preferred embodiment of the invention with drawings.

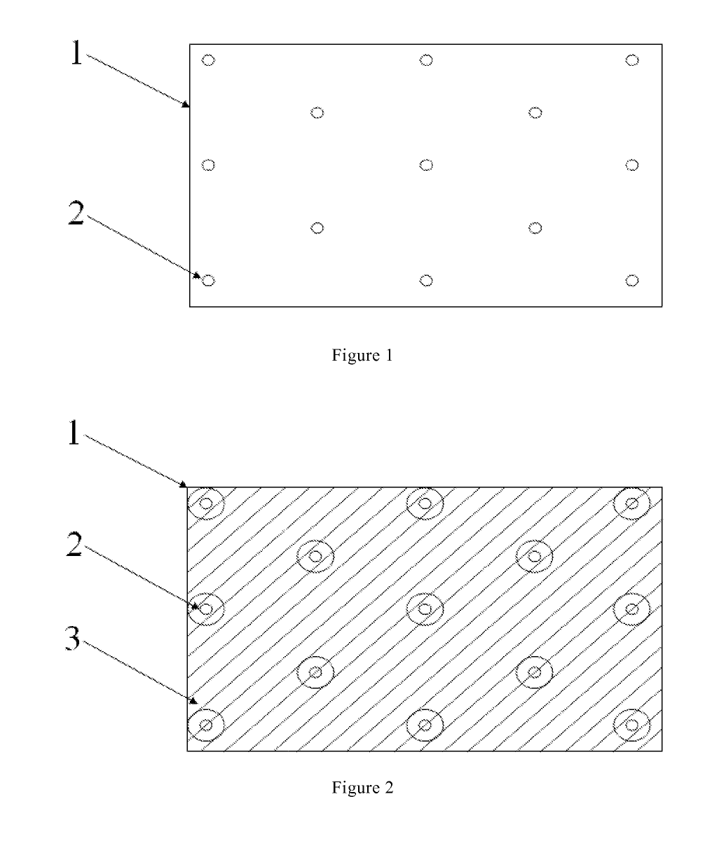

As shown in FIG. 1-6, for a work platform 1 with concave-convex points 2, the invention relates to an optimized method of three-dimensional printing, the method comprising:

A) generate three-dimensional CAD model;

B) separate the three-dimensional CAD model into a series of layers;

C) print the separate layers by the method that spray the given composite material through a nozzle;

D) the bottom layer 3 is printed through the nozzle on the work platform;

E) the layers except the bottom layer are printed after finish the printing of the bottom layer 3 to form the three-dimensional composite model;

The method generates the data of the printing of bottom layer 3 which is also the path for printing bottom layer 3 depend on the concave-convex points 2 on the work platform 1 in procedure B). That is, the bottom layer 3 is the lowest one or several layers of the model.

The basis to achieve the above process is that the applicant controls the data of the concave-convex degree of the surface of the work platform in advance. For example, input the coordinate data of the relative position on the work platform to the software of analysis model to generate the data of bottom layer 3 to confirm the path for printing bottom layer.

In the path of printing bottom layer 3, detouring the concave-convex points 2 on the work platform 1. The second print layer 4 is filled to cover the concave-convex points 2 to form a complete plane. Then, printing the subsequent print layer 5 densely. That is, in order to facilitate the description, the bottom layer 3 is set to 1 layer. But in practice, the bottom layer 3 is usually set to 3-6 layers according to the concave-convex degree of the concave-convex points 2.

Through the optimize way of scanning path above, in the generation of data of bottom layer 3, optimizing the path base on the shape parameter of the work platform 1 set in advance to detour the concave-convex points 2 on the work platform 1 in the process of printing bottom layer 3. The 3D printer is compatible with different shape and surface of the working platform 1 to make the model adhere well with the work platform 1 which avoids the phenomenon of warping at the bottom of the model due to the out-of-flatness of the work platform 1. In addition, the method can protect the nozzle and reduce wear while ensuring the quality of the printing model.

### Embodiment 1

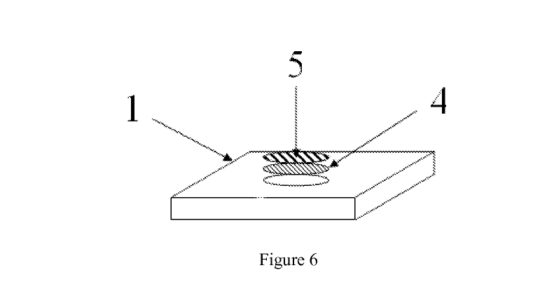

As shown in FIG. 4, the generation of the deviating path in the software model analysis and hierarchical processing. The nozzle moves left or right to deviate the concave-convex points when the nozzle close to the concave-convex points 2 on the work platform 1 in the process of printing bottom layer 3, and then continues to print. Detour the concave-convex points 2 by the way of deviating. As shown in FIG. 6, use the conventional printing method to print the second print layer 4 to cover the concave-convex points 2 which were detoured in the printing of the bottom layer 3 to form a complete plane after finish the printing of the bottom layer 3, and then complete the printing of the subsequent print layer 5 on that plane.

### Embodiment 2

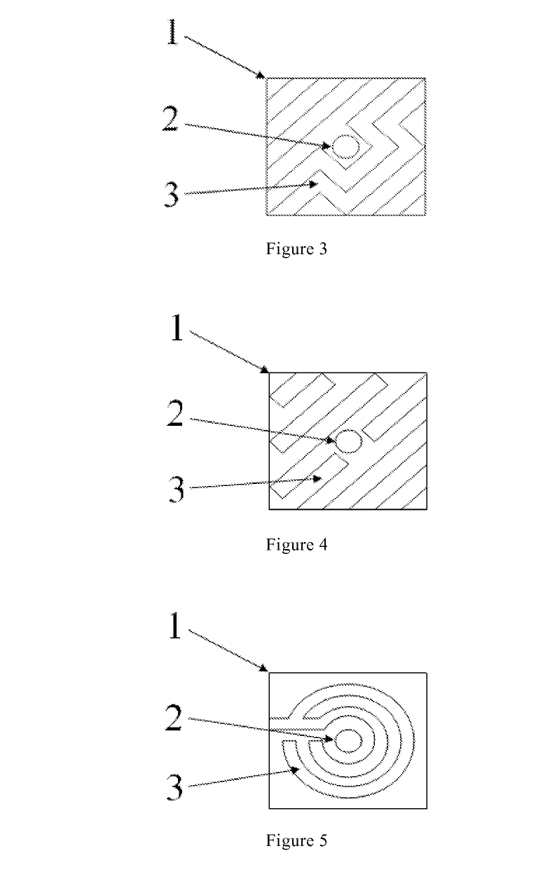

As shown in FIG. 3, the generation of the skipping path in the software model analysis and hierarchical processing. The nozzle moves up and over the concave-convex points when the nozzle close to the concave-convex points 2 on the work platform 1 in the process of printing bottom layer 3, and then continues to print. Detour the concave-convex points 2 by the way of skipping. As shown in FIG. 6, use the same printing method of the embodiment 1 to continue the printing.

### Embodiment 3

As shown in FIG. 5, the generation of the circling path in the software model analysis and hierarchical processing. The nozzle prints around the concave-convex points 2 as a center when the nozzle close to the concave-convex points 2 on the work platform 1 in the process of printing bottom layer 3, and then continues to print. Detour the concave-convex points 2 by the way of circling. As shown in FIG. 6, use the same printing method of the embodiment 1 to continue the printing.

The combination of the above embodiments gives a clearness of description of the present invention. But the invention is not limited to the implementation above. Commonly, various changes without departing from the subject spirit are within the protection scope to those skilled in the art thereof, e.g., detour the concave-convex points 2 by other ways.

1. An optimized method of three-dimensional printing, the method comprising:
A) generate three-dimensional CAD model;
B) separate the three-dimensional CAD model into a series of layers;
C) print the separate layers by the method that spray the given composite material through a nozzle;
D) the bottom layer is printed through the nozzle on the work platform;
E) the layers except the bottom layer are printed after finish the printing of the bottom layer to form the three-dimensional composite model;
wherein the method generate the data of the printing of bottom layer depend on the concave-convex points on the work platform in procedure B).

2. The optimized method of three-dimensional printing in claim 1 having the path of printing bottom layer makes a detour to the concave-convex points on the work platform through the data of printing bottom layer that the shape of the printing path varies according to the different work platform.

3. The optimized method of three-dimensional printing in claim 2 having the nozzle moves to left or right to deviate the concave-convex points when the nozzle close to the concave-convex points on the work platform, and then continue to print.

4. The optimized method of three-dimensional printing in claim 2 having the nozzle moves up and over the concave-convex points when the nozzle close to the concave-convex points on the work platform, and then continue to print.

5. The optimized method of three-dimensional printing in claim 2 having the nozzle prints around the concave-convex points as a center when the nozzle close to the concave-convex points on the work platform.

6. The optimized method of three-dimensional printing in claim 2 wherein printing the second print layer to cover the concave-convex points which were detoured in the printing of the bottom layer to form a complete plane after finish the printing of the bottom layer, and then complete the printing of the subsequent print layer on that plane.

7. The optimized method of three-dimensional printing in claim 3 wherein printing the second print layer to cover the concave-convex points which were detoured in the printing of the bottom layer to form a complete plane after finish the printing of the bottom layer, and then complete the printing of the subsequent print layer on that plane.

8. The optimized method of three-dimensional printing in claim 4 wherein printing the second print layer to cover the concave-convex points which were detoured in the printing of the bottom layer to form a complete plane after finish the printing of the bottom layer, and then complete the printing of the subsequent print layer on that plane.

9. The optimized method of three-dimensional printing in claim 5 wherein printing the second print layer to cover the concave-convex points which were detoured in the printing of the bottom layer to form a complete plane after finish the printing of the bottom layer, and then complete the printing of the subsequent print layer on that plane.
